(19) United States
(12) Patent Application Publication
(10) Pub. No.: US 2017/0289661 A1
(43) Pub. Date: Oct. 5, 2017

(54) INTELLIGENT FLAT SPEAKER PANEL SYSTEM

(71) Applicant: SoundWall, Inc., Broomfield, CO (US)

(72) Inventors: David Hose, Boulder, CO (US); Sven Coppom, Boulder, CO (US)

(21) Appl. No.: 15/495,706

(22) Filed: Apr. 24, 2017

Related U.S. Application Data
(63) Continuation-in-part of application No. 14/214,039, filed on Mar. 14, 2014, now Pat. No. 9,635,444.
(60) Provisional application No. 61/786,051, filed on Mar. 14, 2013.

(51) Int. Cl. H04R 1/02; H04R 7/04

(52) U.S. Cl. CPC H04R 1/026; H04R 7/04; H04S 7/305

(57) ABSTRACT

A flat panel sound system (400) includes an acoustic backing (410) and stand-offs (412) on its back side. The stand-offs (412) are interposed between a frame (406) or housing (408) and the wall on which the sound system (400) is mounted. The sound system (400) further includes an electronic housing (414) and exciters (404) mounted on the frame (406). The electronics within the electronic housing (414) receive wireless inputs from a user interface and drive the exciters (404) to produce an audio output. The stand-offs (412) inhibit transmission of vibrations to the wall and allow acoustic waves to emanate the back side of the flat panel system.

### CROSS-REFERENCE TO RELATED APPLICATION

This application is a continuation-in-part of U.S. patent application Ser. No. 14/214,039 entitled: “DECORATIVE FLAT PANEL SOUND SYSTEM,” filed on Mar. 14, 2014, which claims priority to U.S. Provisional Patent Application No. 61/786,051 entitled “DECORATIVE FLAT PANEL SOUND SYSTEM,” filed Mar. 14, 2013. The contents of these applications are incorporated herein by reference as if set forth in full.

### FIELD OF THE INVENTION

The present invention relates generally to intelligent audio devices and, in particular, to an intelligent audio device based on a flat speaker panel system that can blend unobtrusively or attractively into home or office decor. The system can function as a novel interface for a computer network.

### BACKGROUND OF THE INVENTION

Conventionally, audio systems such as radios and devices for playing back recorded media, were systems with limited intelligence used mainly to deliver an audio output as manually directed by the system user. More recently, audio systems have begun to incorporate more intelligence. For example, iPod® devices, smart phones and MP3 players allow users to construct playlists, receive music suggestions and download content, and also provide a variety of playback options relating to playback sequence and mode, e.g., headphone playback, speaker playback, and driving an associated playback unit via a wireless or wireline connection. In the context of vehicles, an audio system may pause, mute or the like when a phone call is received via an integrated or connected phone. Moreover, desktop and laptop computers can be used as audio systems.

This proliferation of options for delivery of audio content has greatly expanded the conception of what an audio system is and the usage of audio systems. It is now common for people to consume music or other audio content when they are on the move, even during exercise, and at work, while studying, on public transportation or in other environments where use of audio systems would have once been considered improper or disruptive. Moreover, as it has become more convenient to obtain audio content, and exposure to different types of audio content has become less constrained by bandwidth limitations, many people have become increasingly selective concerning audio content and view such content as an important part of their environment and identity.

While consumers therefore demand convenient access to intelligent audio devices, existing systems have limitations that interfere with the goal of convenient, seamless and unobtrusive entertainment and expression of identity. Portable sound systems offer tremendous convenience on the move and can be made to drive external audio components. However, such portable systems remain bound to a device, however small, and users may be captured by the culture of screen obsession. Full size, dedicated audio systems such as stereos can provide excellent audio quality and increasingly incorporate intelligence and convenience similar to portable systems. However, such systems still generally require direct operation or manual operation via a remote control or wireless connection, and generally entail a cabinet, speakers, and the like that significantly impact the aesthetics of the environment. In the latter regard, prominent display of audio equipment is not considered a symbol of status or otherwise desired by all consumers. Thus, despite the many advances that have been made, for many consumers current audio systems fall short of satisfying their lifestyle and sense of self.

### SUMMARY OF THE INVENTION

The present invention is directed to a method and apparatus (“utility”) for sensing stimuli in a surrounding environment and controlling operation of a flat speaker panel based on the stimuli. The utility can sense a variety of types of stimuli for intelligent and customizable operation. Moreover, the utility can be embodied in a flat speaker panel system that can be mounted on a wall for convenient yet unobtrusively access that does not interfere with or even enhances home or office decor. In addition to intelligent online functionality, the system provides a novel interface for data networks.

In accordance with one aspect of the present invention, an intelligent audio utility is provided. The utility includes at least one flat speaker panel and at least one audio exciter for driving that flat speaker panel. The flat speaker panel and exciter are supported by a common structural unit for mounting on a wall. Preferably, the flat speaker panel implements distributed mode loading, as described below, for improved frequency response. The utility further includes a sensor for sensing stimuli in an environment of the flat speaker panel and processing logic for the detecting one or more events based on the stimuli. A processor executes one or more predefined functions responsive to the sensed event and provides an audio output via the flat speaker panel.

In one implementation, the sensor system includes a microphone and the processing logic processes an audio input from the microphone. For example, the utility may include speech recognition logic for recognizing at least one speech based command. In this manner, a user can select audio content, adjust volume, and otherwise control the flat speaker panel via simple voice commands. As a further example, the utility may recognize various ambient conditions and control the flat speaker panel based on those conditions. For example, the utility may sense a conversation, a phone call, or a competing audio signal and reduce the volume of or mute the flat speaker panel. Additionally or alternatively, the utility may sense a presence, identity, mood, or audio preference of at least one person associated with the flat speaker panel. For example, the utility may sense that a particular person has entered the room and commence play of a play list customized for that person. The utility may also sense a gesture in proximity to or a touch of the flat speaker panel. In this manner, a user can control operation of the flat speaker panel when voice commands are not desired without requiring a separate remote control device.

In another implementation, the sensor system includes a set of multiple sensors. For example, the sensor set may include a Bluetooth™ system, a motion sensor and a touch sensor such as a soft potentiometer (SoftPot). In this regard, the flat speaker panel unit mat have a Bluetooth system that identifies and/or pairs with a Bluetooth system of a phone, iPod™ or other Bluetooth enabled device of a user. In this manner, the flat speaker panel unit can sense the presence or proximity of one or more known users, e.g., so as to transition to an active state, play an appropriate playlist, take over music playback or other function from the paired device, set the environment in accordance with user preferences, etc. The motion sensor may include one or more optical, microwave, acoustic, or other sensors effective to sense motion in a monitored area. In this manner, the system can further detect presence or activity (even where Bluetooth devices are not present), or detect gesture commands. The touch sensor can allow for various touch commands such as volume control, function selection, light dimming or the like. It will be appreciated that the sensor set may provide multiple options for executing the same controls in some cases, e.g., multiple alternatives for presence detection or volume control.

The intelligent audio utility may further include an illumination system that can be operated in response one or more events. For example, the illumination system may be activated to enhance a mood or to indicate that the flat speaker panel is active and ready to receive commands. In one implementation, the illumination system may include forward and/or rearward directed LEDs. The utility may further include a network port for connections to a communications network, such as LAN or the internet, and/or a port for wireless communications. The network connection can be used to control other devices, such as lights, thermostats, and security systems. The wireless port can be used, for example, to enable the system to take over audio playback from a portable audio device when desired. It will be appreciated that many other uses of the network and wireless ports are possible.

### BRIEF DESCRIPTION OF THE DRAWINGS

For a complete understanding of the present invention, and further advantages thereof, reference is now made to the following detailed description, taken in conjunction with the drawings in which:

FIG. 1 is a front perspective view of a flat panel sound system in accordance with the present invention;

FIG. 2 is side view of the flat panel sound system of FIG. 1;

FIG. 3 is a schematic diagram of a flat panel sound system in accordance with the present invention;

FIG. 4 is partial rear perspective view of an alternative embodiment of a flat panel sound system in accordance with the present invention;

FIG. 5 is a rear elevation view showing the flat panel sound system of FIG. 4 with a backing removed to reveal internal components;

FIG. 6 is a schematic diagram showing electronic components of the flat panel sound system of FIG. 4;

FIG. 7 is a front prospective view of a flat panel sound system in accordance with the present invention;

FIG. 8 is a schematic diagram of a flat panel sound system in accordance with the present invention;

FIG. 9 is a schematic diagram of a networked multi-media system in accordance with the present invention;

FIG. 10 is a schematic diagram illustrating an intelligent flat speaker panel device in accordance with the present invention;

FIG. 11 is a schematic diagram illustrating a networked intelligent flat speaker panel system in accordance with the present invention;

FIG. 12 is a schematic diagram illustrating a community of intelligent flat speaker panel devices associated with a knowledge base in accordance with the present invention;

FIGS. 13A-13B show front and rear perspective views, respectively, of a flat panel system in accordance with the present invention; and

FIGS. 14A-14D show various configurations of networked flat panel systems in accordance with the present invention.

### DETAILED DESCRIPTION

The present invention is directed to an intelligent flat speaker panel system and associated processes. The system can function as, among other things, an intelligent sound system, a user interface for a data system, a home and health monitoring system, and a home or office environment control system. In the following description, the invention is set forth in the context of specific intelligent flat speaker panel embodiments and use cases. It will be understood, however, that these are set forth as examples and the invention is not limited to these embodiments and use cases.

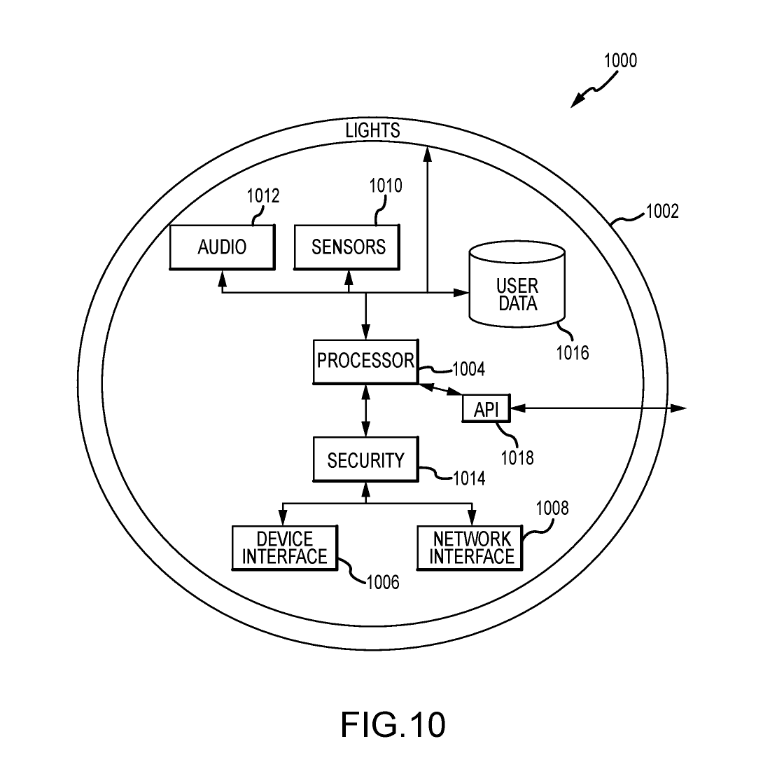

A schematic diagram of an intelligent flat speaker panel device 1000 is shown in FIG. 10. The illustrated device 1000 is embodied as a flat panel-shaped article that can be hung or mounted on a wall. For example, the device 1000 may conveniently be placed on a wall of a home or office where it can be easily utilized by residents or workers as will be described below. The device 1000 may have a front surface that can function as a display surface for displaying desired information during use and/or the front surface may have the appearance of a clock or mirror or may have artwork or a decorative appearance. Moreover, the appearance of the front surface can change over time. In this regard, it will be appreciated that an important advantage of the device 1000 is that it can provide a variety of functionality, including interactive functionality and high quality sound delivery, without interfering with environmental aesthetics or dictating a high technology aesthetic.

The device 1000 can be provided in any of a variety of physical shapes consistent with its desired functionality including, for example, round, square, rectangular, triangular or other geometric or complex shapes. The front surface can be formed from aluminum, wood, acrylic or other plastics, or can be magnetic (for removable art), or formed from other materials. The illustrated device 1000 is depicted for purposes of illustration as being round which may be a practical choice, for example, to accommodate a clock or mirror appearance.

The illustrated device 1000 is schematically shown as including lights 1002. In one implementation, the lights 1002 may include both front lights, that are directly visible from a position in front of the device 1000 and back lights that are not directly visible from the front but provide diffuse, indirect light by illuminating the wall on which the device is placed. In the latter regard, as will be described below, the device 1000 may be mounted in spaced relationship to the wall to improve sound quality as well as to allow for the noted indirect lighting. The lights 1002 may include LEDs, incandescent lights, LCD or other displays, or other light sources. The lights 1002 may be mounted to the flat speaker panel or on a frame that does not move with the speaker panel. It will be appreciated that lightweight light sources may be preferred for lights that move with the speaker panel.

The lights 1002 can be used for various purposes. For example, the back lights may be used to indicate that the device is turned on, in an active state, or otherwise available for use. The back lights may also provide soft lighting for the room or function as a night-light. For example, the back lights may be activated when the presence of a person is detected, in response to a command, or on a timed or scheduled (e.g., a set schedule or a learned schedule) basis. The front lights may be used for signaling and/or room illumination. For example, the front lights may be provided as display elements that provide status, user interface, playlist or other information. The front lights may also be activated based on presence detection, in response to commands or on a scheduled basis.

As noted above, the device 1000 is preferably an intelligent device. In this regard, the device 1000 includes a processor 1004 that may be embodied in one or more microprocessors and associated circuitry and software/frameware. The processor 1004 may receive inputs via, for example, a device interface 1006, a network interface 1008 and sensors 1010, and may provide outputs via the interfaces 1006 and 1008, an audio system 1012 and the lights 1002.

The device 1000 can be aware of and provide notifications concerning other network devices, e.g., an audio or visual notification that “network devices are available.” For example, the other network devices may be other flat panel devices (e.g., of a grouped flat panel array as will be described in more detail below), Bluetooth devices (e.g., phones or portable music devices), computers, printers, wifi enabled household appliances, etc. The availability of such devices may be sensed by the device 1000 via a wireless (e.g., Bluetooth) protocol, a wireless router, a physical Ethernet connection or other pathway. The device 1000 can also be synched with other devices, via wireless or wireline connector, e.g., to access playlists, calendars, contacts, settings or other information.

The device interface 1006 may include any of various user devices that are designed or adapted to interface with the flat speaker panel device 1000, for example, via infrared, radio, electronic (e.g., wireline) or other signals. For example, smart phones, iPods®, computers or other user devices (e.g., smart household appliances/network devices) may communicate with the device 1000 via Bluetooth™ or other wireless technologies. An application may be loaded on the user device to facilitate such communication. Additionally or alternatively, a dedicated remote control device may be provided to communicate with the device 1000 via infrared or other wireless technology. Communications between the device interface 1006 and device 1000 may be responsive to a user command, an input from sensors 1010, a schedule, and may be initiated from the device 1000 or user interface 1006.

The network interface 1008 can allow for communication between the device 1000 and local or remote data devices via a LAN, WAN or the like. Such communication may be accomplished wirelessly (e.g., via a wireless router) and/or via a wireline communication (e.g., Ethernet cable). Wireless communication may be preferred to enhance the unobtrusive aesthetics of the device 1000. Such a network interface facilitates the functionality of many use cases as described below including, for example, remote home monitoring and wellness monitoring, network-based multimedia art presentation, and others.

A security module 1014, such as a commercial firewall, may be interposed between the processor 1004 and at least the interfaces 1006 and 1008. Among other things, the security module 1014 can protect the device 1000 against malware and attacks, against unauthorized access to user data 1016 and resources, and can ensure that only authorized users control the device 1000 and resources impacted by the device 1000.

It will be appreciated that the device 1000 may be used in industrial, not just consumer, applications. For example, the device 1000 or an array of devices 1000 may be deployed in hospitals, schools, hotels, offices, stores or other environments. The sensors employed and capabilities of the device 1000 can be tailored to such environments. For example, the sensors may include smoke or carbon monoxide detectors, sensors for detecting spills or potentially harmful/dangerous emissions, temperature or humidity sensors, or other environmental detectors. Presence or identity detectors can be used for improved customer engagement, e.g., to lure customers, welcome guests or provide targeted advertising. For example, the device 1000 may recognize individuals or devices by detecting RFID signals, e.g., from room keys, guest passes, customer loyalty cards or the like.

The audio system 1012 includes the flat speaker panel, exciters and associated circuit/logic as well be described in more detail below.

Any of a variety of sensors 1010 can be provided as part of the device 1000. Examples include touch sensors (e.g., for tactile control via a touch screen or track pad incorporated with a front or other surface of the device 1000), microphones (e.g., for voice commands, environmental response, or wellness monitoring), cameras, gesture sensors (e.g., for enabling device-free remote commands), IR sensors, radio antennae, and the like. It will be appreciated that the device may further include tactile buttons or other input devices. Moreover, the device 1000 can access, via wireless or wireline direct or network connection, user data such as calendars, documents, social networks, device identifiers and the like, to supplement or comprise sensor inputs.

In order to implement various functions, the device 1000 may have access to user data 1016. The user data may include, for example, playlists, system or environment preferences, content, schedules, personal information, medical information, contact information, security information or any other information relevant to the functionality of the device 1000. The data 1016 may be, for example: stored locally at the device 1000, accessed via a wireless interface, LAN or WAN; and/or distributed across multiple local or remote storage devices. As will be discussed in more detail below, multiple flat panel units may be connected to a network or to one another (directly or via a network).

An API 1018 may be provided to facilitate interaction between the device 1000 and external devices/components. The API 1018 may specify, among other things, protocols, definitions, and tools for exchanging information or developing software for interaction between the device and the external devices/components. In this manner, authorized applications can be enabled to send or receive music/playlists, control signals for lights, volume, temperature, etc. and other information.

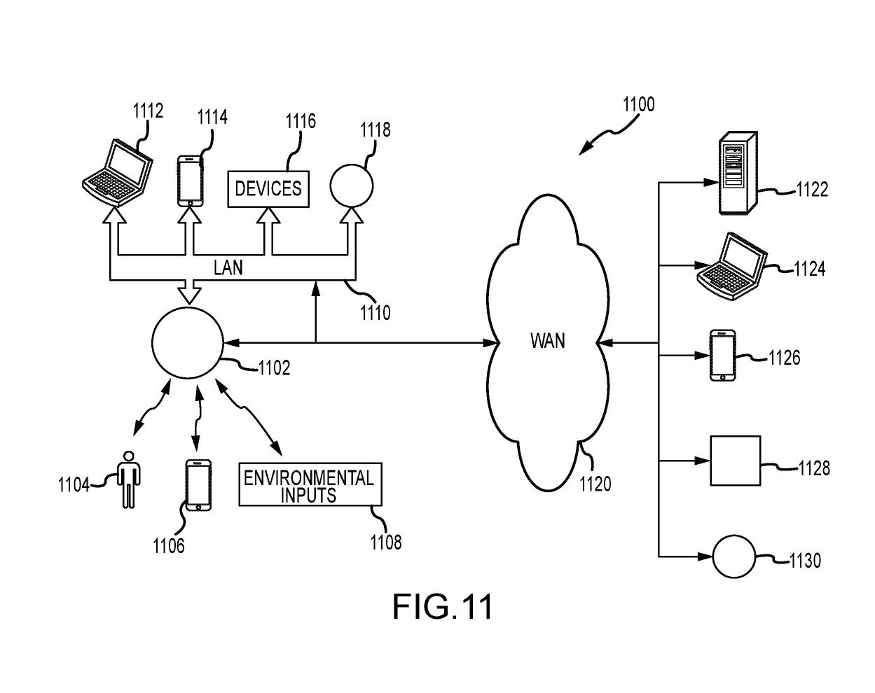

FIG. 11 further illustrates a network environment of an intelligent flat speaker panel system 1200 including one or more flat speaker panel devices 1202. In the illustrated system 1200, the panel device 1202 can directly communicate with a user 1204 (e.g., tactile, voice/sound, or gesture inputs) or a user device 1206 (e.g., smart phone, iPod®, tablet, laptop, remote control, etc.), and can receive environmental inputs 1208 (e.g., detect a phone ringing, conversation, a temperature, a quiet environment, a sleep state, a light or dark environment, a medical emergency, a competing sound source, etc.). These commands or other sensed inputs can trigger a variety of learned or programmed responses. As shown, the panel device 1202 can not only receive inputs from these elements 1204, 1206, and 1208, but can also provide outputs, e.g., to direct operation of the user device 1206. Multiple flat speaker panel devices 1202 can be connected, e.g., for coordinated or distributed operator of various functions, e.g., playlist handoff, spatially distributed sound, etc.

The panel device 1202 can also communicate with various other devices via one or more LANs 1210. For example, the panel device 1202 can communicate with networked devices via a wireless router of a LAN associated with, e.g., a residence or business. Such networked devices may include a laptop 1112, a smartphone 1114, other networked devices 1116 (e.g., alarm systems, smoke detectors, thermostats, televisions, refrigerators, door locks, automobiles, other internet-of things devices, and the like), and other panel devices 1118. An application may be provided for such devices and an appropriate public or private API may be defined for such communications.

In the illustrated embodiment, the panel device 1102 can also communicate with remote devices via a WAN 1120 such as the internet. Such remote devices may include servers 1122 (e.g., for accessing information and remote resources, and for compiling a knowledge base including information harvested from panel devices 1102 and other devices), computers 1124, mobile devices such as smart phones 1126, other data devices (e.g., emergency networks, employer networks, etc.) and other panel devices 1130 (e.g., of a friends or contacts network).

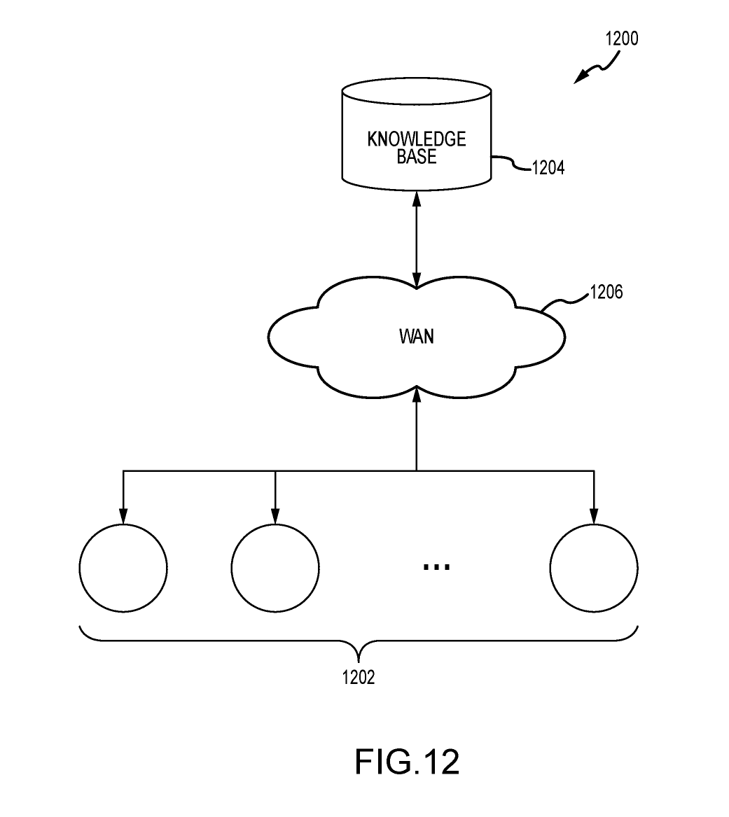

One type of application environment 1200 enabled by such networking is illustrated in FIG. 12. In the illustrated environment 1200, multiple panel devices 1202 are associated with a knowledge base 1204 via a WAN 1206. The devices 1202 may be part of a limited network (e.g., a “friends” group) or a broader network (e.g., a population defined by a common medical condition). The panel devices 1202 can build and/or access the knowledge base 1204. For example, sensors of the panel devices 1202 can harvest information—e.g., concerning sleep patterns, favorite music, television shows/commercials viewed, awake/sleep times, home/away times and the like—that can be analyzed to yield information of interest to doctors, researchers, advertisers, artists, network providers, demographers, sociologists, etc. Conversely, users can employ the devices 1202 to access or benefit from information of the knowledge base 1204, e.g., to identify music, programs or products of interest, or to receive environmental influences to enhance health, happiness or productivity (e.g., sleep enhancing sounds/temperature, concentration enhancing sounds, lighting or temperature, or mood enhancing environmental influences).

The intelligent flat panel speaker system can then support a variety of use cases as exemplified by the following discussion.

### Use Case 1—Intelligent Music System

The intelligent flat panel speaker system as described above provides excellent sound quality via an unobtrusive or attractive device, and can communicate directly with devices such as iPods or other mobile devices as well as with other devices (computers and remote servers) via networks. The system can therefore execute functionality of smart sound systems such as accessing playlists, streaming, providing listening recommendations and the like.

Moreover, the system can leverage other attributes of the system and the network environment as described above for enhanced functionality. For example, various sensor inputs can be used to execute advanced functionality. Presence detectors (e.g., motion detectors, infrared detectors, Bluetooth pairings) can be used to determine presence and/or identity so as to select appropriate playlists or to “take-over” playing of a playlist from a portable music device, e.g., upon returning to home. This take-over function may be implemented automatically or on command. The take-over function can also switch to a different playlist or a composite/blended playlist (incorporating songs from multiple playlists) when multiple people are present. Other devices can also be synched with music libraries via the panel system.

Similarly, a microphone may sense ambient sounds (e.g., a phone ringing, a conversation, a television, a concentration mode, a sleep state, etc.) and adjust a music/sound output based on the sensed environment (e.g., reduce/increase volume, interrupt music, select an appropriate playlist or other audio output, etc.). Such inputs may be used together with a programmed or learned schedule (or a schedule may be used alone) to improve system performance.

### Use Case 2—Personalizing Environment

The panel system can also personalize various environmental factors such as lighting, temperature, sound (as noted above) and providing reminders/alerts. The panel system can control various network-of-things devices (lights, thermostats, door locks, etc.) through its network environment and further includes integrated functionality such as sound and light elements. Moreover, because the panel system can be conveniently located in living or work spaces without interfering with, or even enhancing, decor, the panel system functions as an ideal input/output device. User preferences can be programmed and/or learned. For example, the system can: provide the desired lighting/temperature based on presence or time of day/day of the week; provide reminders to take breaks after a certain length of concentration mode or change the music/audio output to indicate a break interval or induce a break in concentration mode; terminate music upon departure or initiation of sleep; lock doors upon departure or sleep; etc.

### Use Case 3—Wellness

The panel system can also promote wellness. As noted above, the sensors can detect sleep states and interruptions of sleep states and can provide audio outputs (music, white noise, peaceful sounds) to enhance sleep. It will be appreciated that the panel system or separate sensors (e.g., sound sensors, motion detectors, etc.) can be disposed adjacent sleeping locations. In this manner, the panel system can assist in treating insomnia, sleep apnea, or other sleeping disorders as well as promoting deep sleep for others.

Similarly, the system can assist in monitoring at risk individuals. For example, the system can detect potential seizures or accidents and contact emergency responders or provide instructions or environmental responses (audio stimulus or temperature control). The system can also detect unusual or risky behavior by persons experiencing bouts of dementia (e.g., leaving the premises unattended, unusual patterns of movement, leaving water running, incoherent or repetitive speech, etc.). Many other wellness-related behaviors or events can be monitored and addressed via the panel system.

### Use Case 4—Remote Monitoring and Control

As noted above, the panel system may include motion detectors, cameras, thermostat controls, door lock controls and other sensors and controls as well as network interfaces. Accordingly, the panel system is well-suited for remote monitoring and control of a residence or workplace. For example, motion detectors can detect the presence of an individual at an unusual time and activate cameras, lights, alarms and first responders. Because of the unobtrusive design, the panel system will not be readily identified as a security device unless so desired (e.g., by displaying a warning message). Moreover, a user can employ the flat panel system to remotely control temperature, lighting and music as desired.

Many of the features of the present invention as described above rely prominently on the core element of a self-contained flat speaker panel. The flat speaker panel preferably reduces or eliminates cords or network connections that would distract from the desired aesthetics of the device. While some effects have been made to free computer interfaces from input devices (e.g., voice controls) and some effects have been made to implement intelligent control of music players, the present invention integrates device free input, environmental awareness and high performance audio output in an unobtrusive or attractive device. Certain embodiments of the core, self- contained flat speaker element are described below.

As will be understood from the description above, an important part of the present invention is the flat panel sound system. The following description describes a flat panel system in accordance with the invention in the exemplary context of a wall-mounted sound system associated with a mobile device such as an Apple iPhone™ data enabled mobile device or any communication protocol including servers, custom apps, etc. It should be expressly understood that the invention is not limited to such embodiments or contexts. For example, a wired connection for Ethernet and/or power may be utilized instead of implementing the system as a fully wireless unit.

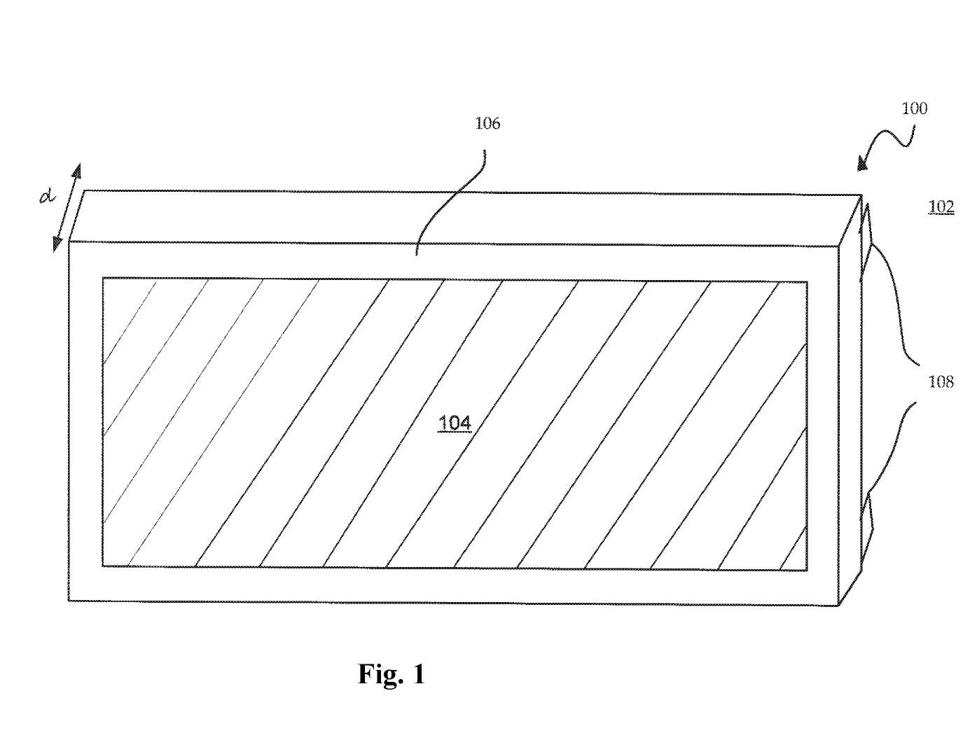

FIG. 1 illustrates a sound system 100 in accordance with the present invention. The illustrated system 100 is a flat panel system adapted to be mounted on a wall 102. The sound system 100 is designed to be decorative or unobtrusive. For example, the system 100 may not appear to be a sound system at all to the casual observer, but may instead appear to be a picture, a mirror, a white-board or the like. In this regard, the illustrated system 100 has a front surface 104 that may have a picture printed on it, or may otherwise be treated in a manner so that it can function as a white-board, projection screen, or mirror. As will be understood from the description below, the front surface of 104 may be formed from a rigid foam board, fiber board, aluminum, aluminum laminate, magnetic or other lightweight, rigid material that operates as a flat speaker panel.

The flat speaker panel, in the illustrated embodiment, is housed within a frame 106. The frame 106 may be mounted on the rigid board or the board may be allowed to move independently of the frame 106 when generating acoustic waves. For example, the foam board may be mounted to float in relation to the frame similar to the mounting of conventional speaker cases. The illustrated sound system 100 also includes buffering devices 108, as will be described in more detail below, that serve to isolate the system 100 from the wall 102 so as to inhibit transmission of vibrations between the wall and sound system. The buffering devices 108 also facilitate transmission of sound waves from the back of the speaker panel into the surrounding environment.

The illustrated sound system 100 may be provided in a variety of dimensions. For example, the front surface of the system 100 may have a size typical of wall mounted pictures. For example, the system 100 may have a width between about 2 to 6 feet and height between about 1 to 4 feet. However, other sizes and aspect ratios are possible. The illustrated system 100 has a narrow depth, d, of less than about 6 inches and, more preferably, no more than about 4 inches. For example, the illustrated system 100 may have a depth, d, between about 2.5-4 inches. The sound system 100 may incorporate an integrated subwoofer.

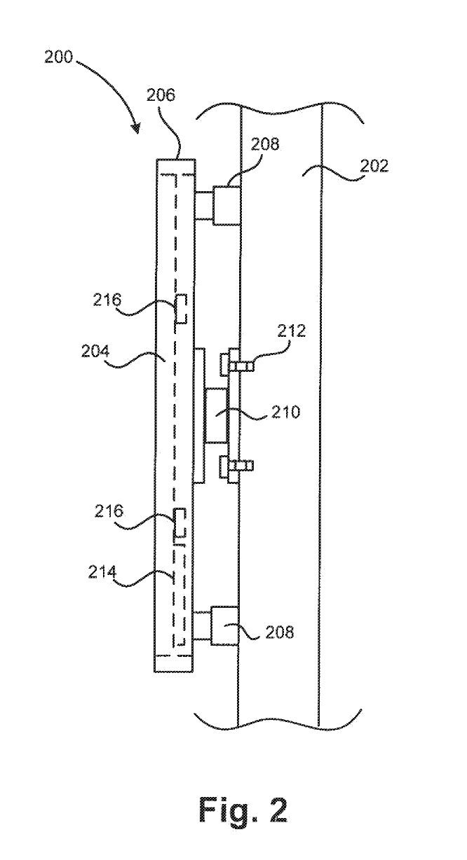

FIG. 2 shows a side view of a flat panel sound system 200 in accordance with the present invention mounted on a wall 202. The illustrated system 200 includes a rigid foam board flat panel 204 mounted within a frame 206. The system 200 further includes a sound kit 214 mounted on the panel 204 or mounted on the same structural frame as the panel 204. As will be described in more detail below, the sound kit may include an amplifier, a computer, an RF antenna, an optional power source such as a battery, and integration circuitry. In lieu of or in addition to the battery, the system 200 may utilize a power connection to the system 200 (e.g., a 120 v ac to 12 v dc or 19 v dc power supply. Also provided as part of the kit are audio exciters 216 that may be connected to the noted components 214 via wires extending behind the foam board 204. The system 200 may further include interface slots for connecting additional or external components such as battery recharger cables, USB flash drives, or other components.

The illustrated system 200 is mounted to the wall 202 using a mounting bracket 210. The mounting bracket may connect to the frame 206, a cross member, or the like and preferably provides sufficient clearance from the wall to provide high quality sound. In this regard, the bracket may be manually or automatically movable to extend the sound system further from the wall. The manner of mounting the system 200 on the wall 202 allows the foam board panel 204 to float as necessary to generate acoustic signals. The illustrated system further includes damping elements 208 for inhibiting transmission of vibrations between the wall 202 and the system 200. These devices 208 may be active or passive. For example, the devices 208 may comprise a resilient material such as foam, may include spring-based shock absorbers or may incorporate electronically driven vibration cancelation units.

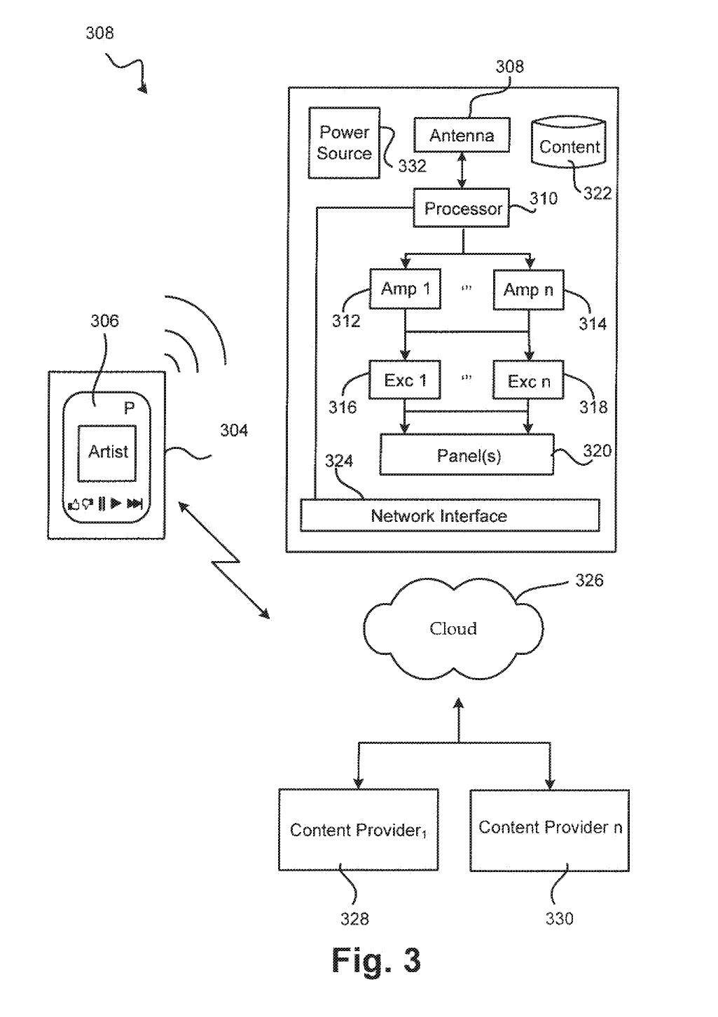

FIG. 3 is a partially schematic diagram of a sound system 300 in accordance with an alternative implementation of the present invention. The illustrated system 300 includes a flat panel speaker system 302 that is wireless controlled by a user interface device 304. The user interface device 304 includes a user interface element, a processor and related circuitry, and a wireless transmitter such as RF antenna, infrared transmitter, or the like. The user interface element, for example, may include a touch screen, a keyboard, a stylus, and/or a graphical user interface. The user interface device 304 may be embodied in a laptop, tablet computer, desktop computer or other data terminal, a mobile unit (e.g., running an Apple™, Droid™, Windows' or other operating system), an iPod™ (particularly if it supports WIFI and AirPlay™) or other mobile music platform, a television, a stereo or other device. In the illustrated embodiment, the user interface 304 is a data enabled mobile unit.

The speaker system 302 includes an antenna 308, sensor or other unit for receiving the signals from the user input device 304 and a processor 310 for controlling operation of the speaker system 302. In addition, the speaker device 302 includes a number (one or more) of amplifiers 312, 314 and a number of exciters 316, 318 for driving one or more flat speaker panels 320. Multiple amplifiers and exciters may be used to increase volume and to achieve various effects such as stereo sound. The speaker system 302 may further include stored content 322, for example, stored on a removable flash drive or on an integrated solid state storage device. For example, music content may be stored at the speaker system 302, on the user interface device 304 or may be streamed from an external source as will be described below. The system may also include a power source 332, such as a rechargeable battery or a power line for connection to a power outlet.

The illustrated speaker system 302 further includes a network interface 324 such as a connection to a wireless network, wireless router, a hot spot, or the like. Alternatively a wire-line Ethernet connection or the like may be provided as a network interface. Such a network interface may be utilized to access streaming content such as web-based radio or to download content from various online sources. In the illustrated embodiment, the network interface 324 can be used to access content from content providers 328, 330 via a cloud architecture 326. Such content may be streamed in real-time or may be stored in content storage 322. For example, the content may be streamed via a Bluetooth protocol from a paired device.

Alternatively, the user interface device 304 may be utilized to directly access content from the content providers 328, 330, or to access any data network, radio network or other broadcast sources, and to transmit to the content to the speaker system 302. In the latter regard, it will be appreciated that it is not necessary for the speaker device 302 to include a network interface (other than via user interface device 304) or locally stored content 322.

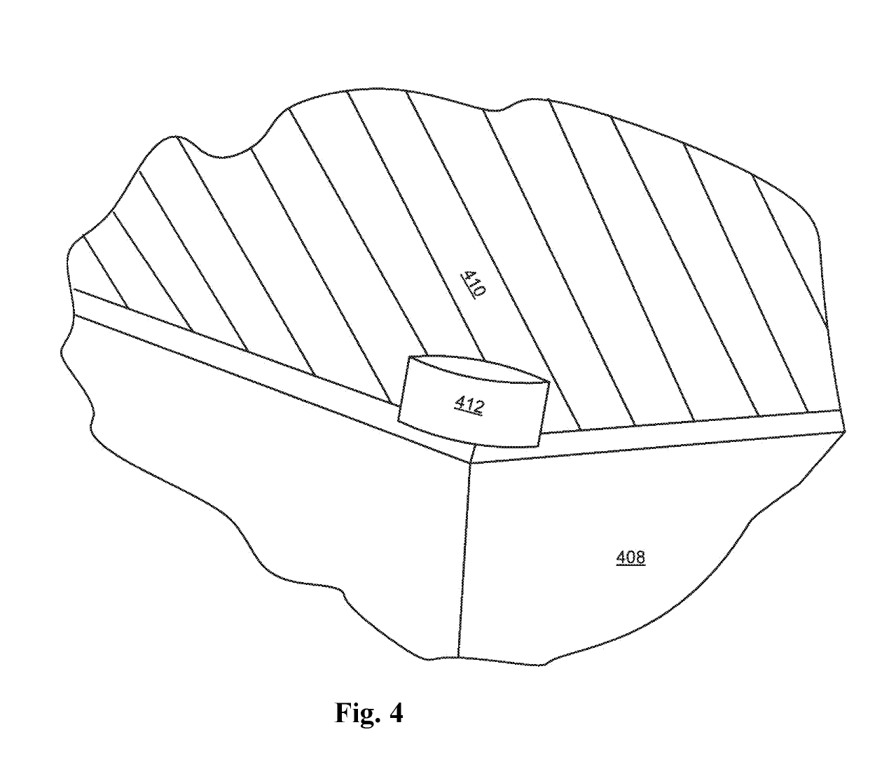

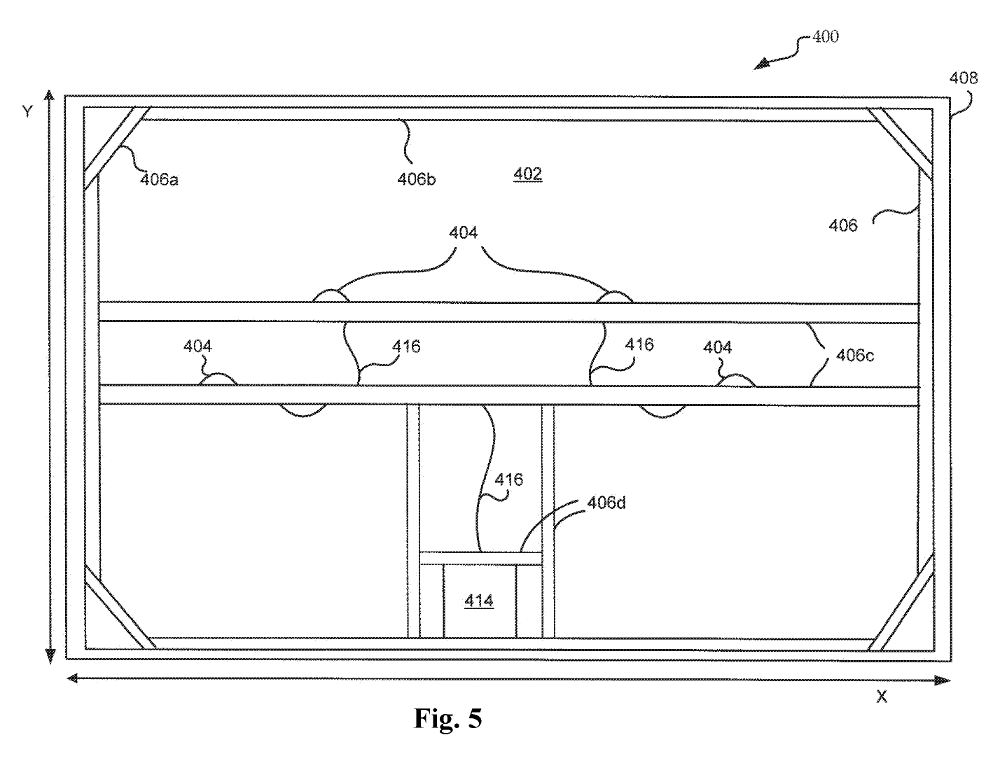

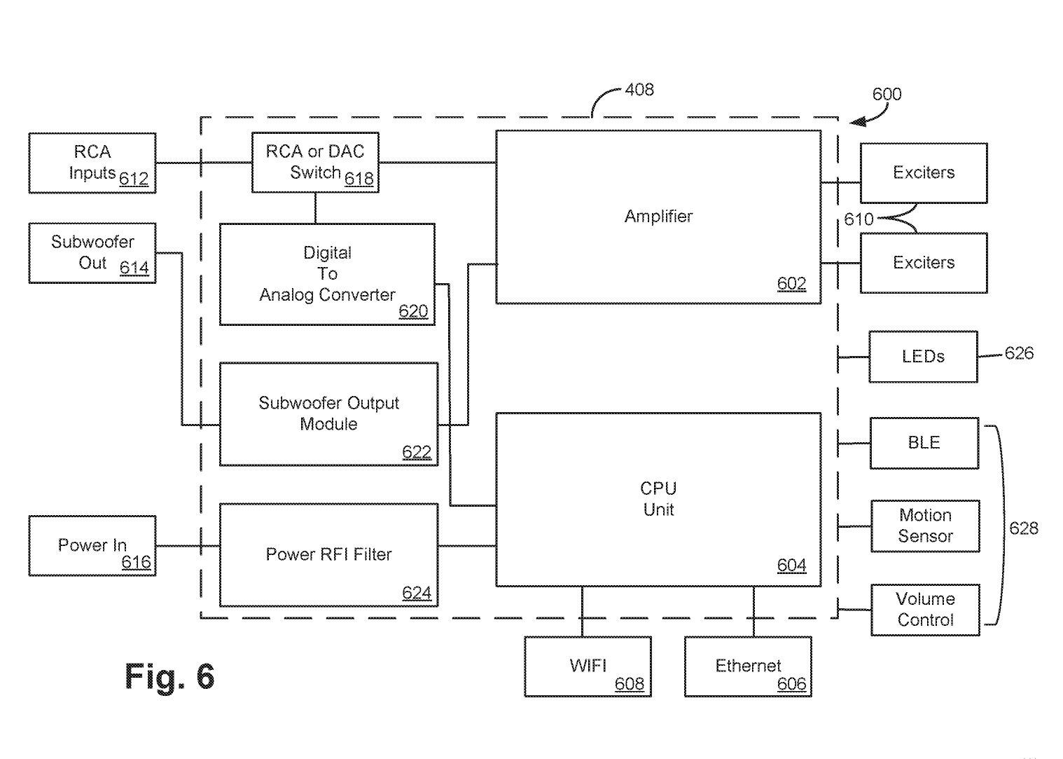

FIGS. 4-6 illustrate a further embodiment of a sound system 400 in accordance with the present invention. In particular, FIG. 4 shows a partial back perspective view of the sound system 400. FIG. 5 shows a back view with the acoustic backing removed to reveal certain internal structure. FIG. 6 is a schematic diagram of the electronics of the sound system 400.

The sound system 400 is generally a flat panel sound system such as described above, but with some differences relating to arrangement of components and a few variations of features. More specifically, the sound system 400 generally includes a flat panel 402 for generating sound. The flat panel 402 is driven by exciters 404 mounted on frame 406. The frame 406, in turn, is supported by a housing 408. As described above, the sound system 400 can be hung or otherwise mounted on a wall and the front surface of the panel 402 may have artwork or other graphics/treatment so that the sound system 400 is unobtrusive or attractive in appearance.

In this regard, the system 400 may allow for changing the art over time. For example, the flat panel 402 may be formed from or include magnetic material such that art can be magnetically attached and changed-out as desired. The panel 402 may also be formed from adorned or unadorned aluminum to enable a variety of visual effects. In addition, the art can be framed, as described above, or floating. In the case of floating art, the art is not enclosed by a frame. For example, the panel with the artwork can be longer than the associated frame elements so that the art appears to float.

As shown in FIG. 4, the illustrated sound system 400 includes an acoustic backing 410 and stand-offs 412 on its back side. The backing 410 is formed from material that allows sound waves to pass through the backing with minimal attenuation or distortion. It has been found that transmitting sound from the back surface as well as the front surface of the panel 402 significantly enhances sound quality. For example, the backing may be formed from any of various natural or synthetic, woven, or mesh materials forming a sound permeable weave or mesh. For example, the backing 410 may be formed from a sheet of loose nylon weave fabric or conventional sound speaker fabric. The backing 410 thus serves the dual function of transmitting sound rearwardly from the panel 402 and covering/protecting the internal structural and electronic components.

The illustrated system 400 further includes stand-offs 412 interposed between the frame 406 (FIG. 5) and/or housing 408 and the wall on which the system 400 is mounted. As noted above, it is desired to transmit sound from the back surface of the panel 402. The stand-offs 412 facilitate transmission of these sound waves into the room or other surrounding environment by providing a gap between the housing 408 and the wall for substantially uninhibited sound transmission. The stand-offs 412 further inhibit transmission of vibrations from the system 400 to the wall. As noted above, the stand-offs 412 can include active vibration canceling devices, moving mechanical devices (e.g., spring-based systems, pneumatic cylinders, or the like), and/or can include passive buffer materials. In the illustrated embodiment, the stand-offs are formed from woven fabric pads having a thickness (front-to-back), for example, of between about 0.25-1.0 inches. The stand offs are disposed near the corners of the housing 408 and may be supported, for example, on the housing 408 and corner braces 406a of the frame 406 (e.g., with the backing 410 sandwiched therebetween).

The housing 408 has a depth (front-to-back) sufficient to house the frame 406, electronic and other internal components. In this regard, the frame may be between about 1.0-8.0 inches deep, e.g., 2.0-6.0 inches deep. The frame 406 may be formed from any suitable material such as wood, particle board, metal, plastic, or composite materials.

FIG. 5 shows the system 400 with the backing removed so that the internal components can be observed. The internal components include the frame 406, electronics housing 414, the exciters 404 and wiring 416 for connecting the exciters 404 to the electronics located within housing 414.

The illustrated frame 406 includes peripheral segments 406b (which may be separate from or integral with the housing 408), crossmembers 406c, electronics support members 406d and cover braces 406a. The exciters 404 are mounted on the crossmembers 406c and are positioned to provide optimal sound. In the illustrated embodiment, there are four at least exciters 404 and they are positioned as follows (where the width of the panel 402 is x and the height is y, with the origin of the lower, left corner of the panel as viewed from the front):

Exciters 1: 4/9 X, 3/7 Y

Exciters 2: 4/7 X, 5/9 Y

Exciters 3: 3/7 X, 4/7 Y

Exciters 4: 5/9 X, 4/9 Y

The exciters can be a mix of different types including, for example, high power exciters for bass and lighter exciters for high frequencies. The support structure for the exciters enhances the sound quality including improved bass performance.

The illustrated electrical support members 406d are configured to support the electronics housing 414 in a bottom, center position in relation to the housing 408. This is a particular advantageous location for the electronics housing 414 as optional ethernet cables, recharger cords, flash drives, power cords, and the like, can be ported adjacent to the electronics housing 414 (e.g., via ports provided on a bottom edge of the system 400) with minimal visual impact and less tendency to pull the system 400 crooked on the wall. The corner braces 406a provide rigidity to the frame 406 and provide support surfaces for the stand-offs 412. The frame 406 may be formed from any suitable material(s) such as wood, particle board, plastics, metals, and/or composite materials, and the various components of the frame 406 can be formed from the same or different materials. The panel 402 can be formed of various lightweight, rigid materials, such as foam board, aluminum or carbon fiber board. In one implementation, the panel 402 is formed from an aluminum composite material including a PVC core sandwiched between bonded aluminum veneers.

As discussed above, various options are available with regard to picture framing. For example, the system 400 can be in a picture frame (supported on the panel 402 or supported on the frame 406 or hanging 408 such that the panel 402 floats in relation to the picture frame) or can be frameless (the edges of the panel 402 are flush with the frame 406).

FIG. 6 illustrates the electronic components 600 of the sound system 400. Though various configurations are possible, the components within the box shown in phantom are housed within the housing 408 of the illustrated embodiment. The sound system 400 may receive inputs from a variety of sources including wireless networks, other data networks, flash drives, mobile devices, televisions, etc. In this regard, the sound system 400 may be configured with ports to receive such inputs. In the illustrate example, the sound system 400 includes an Ethernet port 606 (e.g., for receiving an Ethernet cable), a WIFI port 608, RCA inputs 612, a power in port 616 (e.g., for receiving a power cord or recharger cord). It will be appreciated that other ports such as a USB port and/or other types of audio jacks may be provided. The electronic components 600 also include outputs to drive the panel 602 and external components. In the illustrate example, the outputs include the exciters 610 and a subwoofer 614. For example, one or more separate subwoofer units may be driven by the electronic components 600 via a wired or wireless connection.

The electronic components 600 further include an amplifier 602 and a CPU unit 604. The CPU unit 604 generally executes all of the logic necessary to: receive and decode, demodulate, and otherwise process as necessary the input signals; drive the various internal and external components; and otherwise manage operation of the sound system 400. It will be appreciated that although a single CPU unit 604 is shown, the noted functionality may be distributed over multiple units and may be shared between logic resident on the sound system 400 and external systems.

The amplifier 602 amplifies and otherwise conditions signals from the CPU unit 604 for driving the exciters 610 and the subwoofer output module 622. The amplifier 602 may receive analog inputs or digital signals from the CPU unit. In the case of digital signals, the signals can be converted to analog by the digital to analog converter 620. Switch 618 allows the amplifier 602 to receive signals from the RCA input 612 or from the CPU unit 604 via the digital to analog converter 620.

The illustrated system further includes lights, such as LEDs 626, and sensors 628. The LEDs 626 may include a series of colored LEDs that are programmable to provide a variety of effects. For example, the LEDs may be mounted on a floating aluminum or aluminum laminate panel and may be activated wirelessly or by using a touch bar. As noted above, a variety of different sensors 628 may be provided for a variety of industrial or consumer applications. The illustrated sensors include a Bluetooth antennae (BLE), at least one motor sensor and a volume control. The BLE enables presence detection and identification based on recognizing a pairable device and further enables short range wireless exchange of messages and data between the system and a paired device. The motion detector, such as an IR motion detector, can provide presence detection (e.g., to activate the device or provide lighting) as well as inputs for gesture commands. The volume control may be provided, for example, as a softspot touch control. Additional touch activated controls can support other functions such as audio control (e.g., stop, skip, mute, change playlist, etc).

The illustrated electronic components 600 further include a subwoofer output module 622 and a power RFI filter 624. The RFI filter 624 removes radio frequency interference from the power in signal for improve performance. The subwoofer output module 622 drives the subwoofer via a wireless output, fiber output or other cable output.

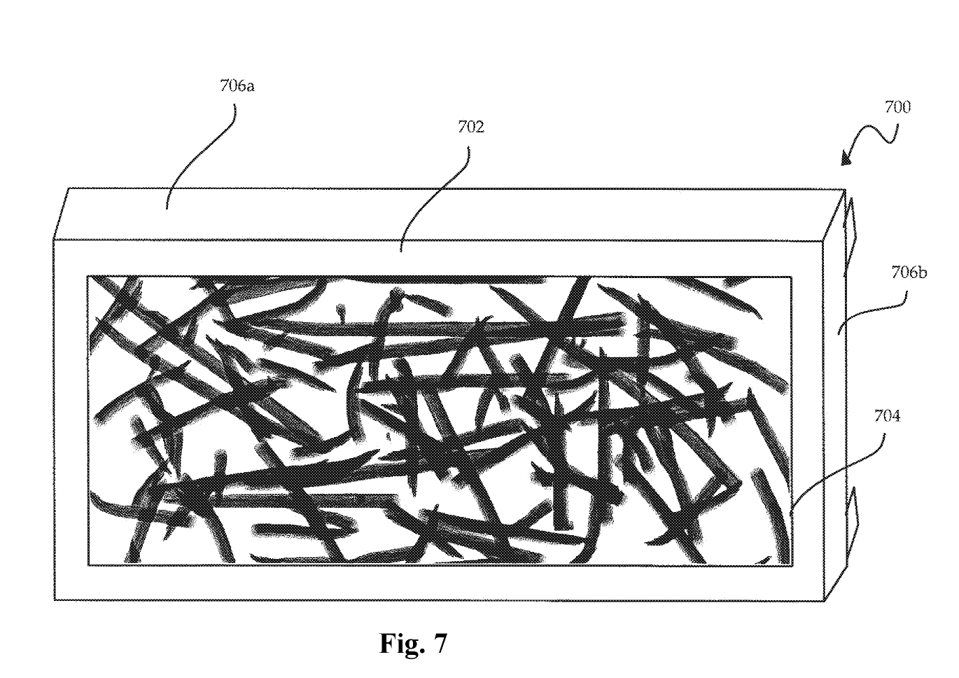

FIG. 7 illustrates a system 700 wherein a visual artistic expression 704 is presented on the front surface 702 of the flat panel speaker. It should be appreciated that a visual artistic expression may be presented on more than a single surface of the speaker system assembly. For example, an image may be displayed on the front surface 704 and on the side surfaces 706 of the assembly.

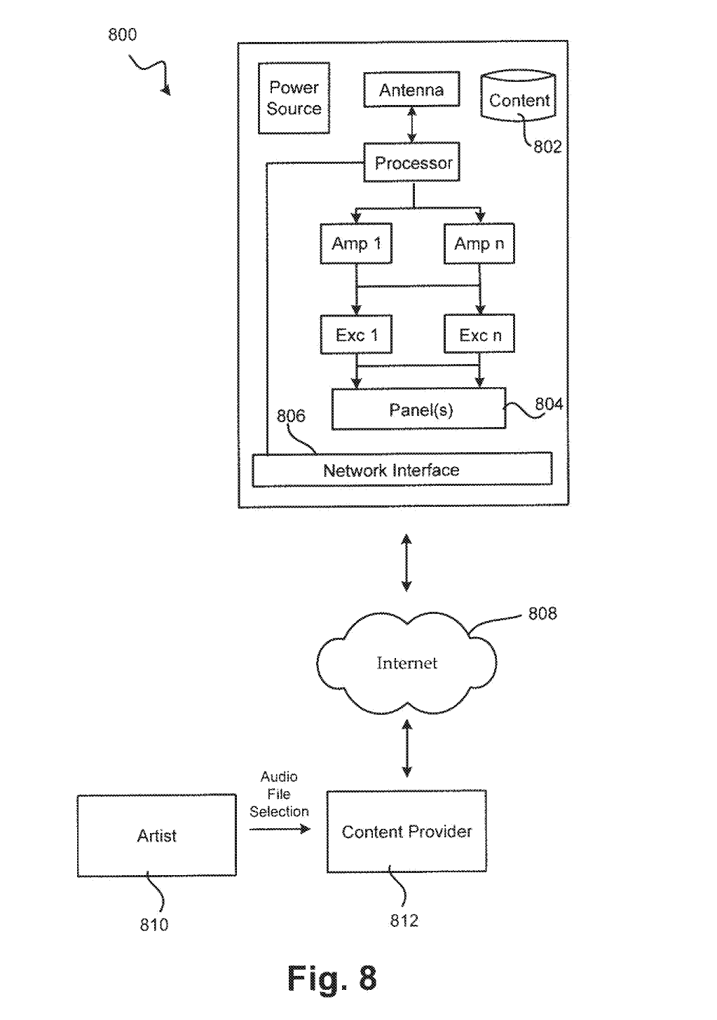

FIG. 8 is a partially schematic diagram of a sound system 800 in accordance with an embodiment of the present invention. The illustrated system 800 includes audio content 802 which may include music, nature recordings, digital sound files, etc. Such content 802 may be preloaded onto the system during manufacturing, downloaded after installation, or streamed.

In an embodiment, an artist 810 associated with a visual artistic display presented on the speaker panel 804 may select an audio file to be played on the sound system 800. The file selection made by the artist 810 is transmitted to the content provider 812. The sound system 800 receives the selected audio file from the content provider 812 through the internet 808 via the network interface 806. The file may be downloaded to the system 800 or streamed from the content provider 812.

The content provider 812 may be a music streaming application such as Pandora, Google Music, or Spotify. The content provider 812 may also be a social media application such as Facebook, Twitter, or Instagram. In such a case, the artist 810 responsible for selecting the audio file may be a collection of social media participants who vote or otherwise select the audio to accompany the visual artistic expression.

In the embodiment, the selected audio file may be transmitted to the sound system 800 via the antenna. In such an embodiment, the audio may be publically broadcast such that multiple owners of a sound system 800 with similar visual artistic expressions receive the same audio transmission simultaneously. Alternatively, the audio may be broadcast locally, for instance, within an art gallery.

It is to be appreciated that the selected audio file may, on occasion, be changed. For instance, a sound system 800 owner may subscribe to a particular artist's 810 service. The artist 810 may choose to replace the selected audio file, in which case the content 802 on the sound system 800 would be replaced or amended.

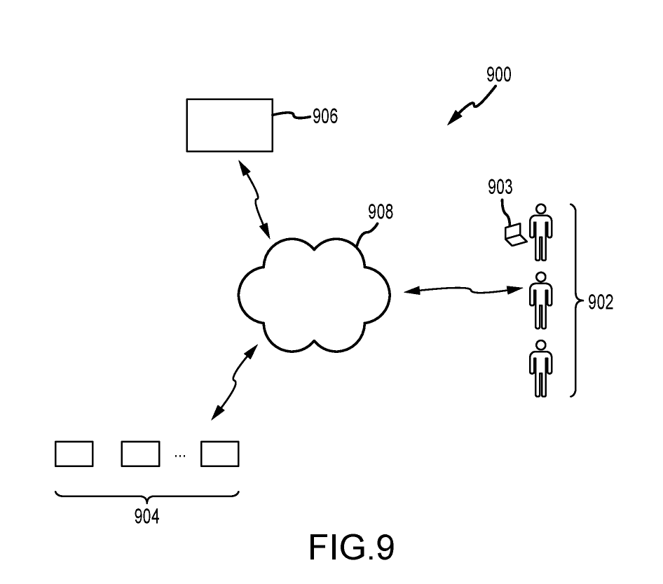

FIG. 9 illustrates a networked multi-media art system 900 in accordance with the present invention. Traditionally, paintings and visual arts, on the one hand, and music and aural arts, on the other hand, have been distinct art forms. The illustrated system 900 provides the opportunity to combine visual artwork, such as a painting or printed photograph, with music or an audio message or effect in a single platform. Artists can use this platform to create impressions beyond the limitations of previous art forms. Moreover, the network environment enables the creation of impressions that evolve or change over time. Moreover, as noted above, multiple flat panel systems can be networked together. These panels can be independently controlled or collectively controlled to create a composite effect. For example, a composite artwork may be distributed over multiple adjacent or remote panels or audio may be transferred from one room to another as the user moves.

While the impression created may be expanded by the creativity of artists, examples include the following. An artist may desire to associate a painting with a musical score, poetry reading or other sound track. The painting and/or soundtrack can vary over time to create an evolving effect. If desired, the painting or soundtrack can change or activate based on presence, identity, mood, activity or the like, all of which may be sensed as described above.

Other artists may provide a periodically varying visual or audio presentation on a subscription basis. Still other artists may provide blog-like audio or textual messages to patrons. Still other artists may provide temporarily varying audiovisual collages. Also, album artwork may be displayed on the panel.

All of this is enabled by the illustrated system 900. The illustrated system 900 involves artists 902 and flat panel devices 904 connected to an AV art portal 906 via a WAN 908. The portal 906 maintains a data structure for indexing particular devices 904 and/or particular pieces of art work to particular artists and provides an interface for enabling the artists 902 to upload and control content for delivery via the device 904.

Thus, an artist 902 using a data terminal 903 can modify or supplement a piece of artwork, for example, by associating audio content, text or the like with the artwork. Then, the artist can access the portal to upload the modified artwork and associate the artwork with an existing work. The portal can then match the modified work to a portion of the original work and download the modified work to the appropriate device 904. Alternatively, the artist 902 can access the portal 906 and select a piece of artwork for modification or supplementation. The artist can then upload supplemental content (e.g., audio files, text files, image files, etc.) and specify any parameters associated with the added content, e.g., time of day for presentation, identity/demographics of viewers for presentation, number of viewers present, mood or trigger events, frequency of presentation, total number of desired deliveries, dependencies on simultaneous environmental factors (e.g., “display this text when particular music, video programming or glare is sensed”), etc. It will be appreciated that the additional or supplemental content may be controlled by an application disposed on the device 904 or a local network, thus providing dynamically variable content without requiring online connection. Moreover, the dynamic content can be downloaded from the portal 906 in real-time or forwarded to the device 904 ahead of expected presentation, e.g., to enable presentation dependent on local conditions.

It will be appreciated that this functionality is not limited to artists. Many others may find the system advantageous such as authors, lecturers, self-help professionals, physicians, psychologists and therapists, just to name a few.

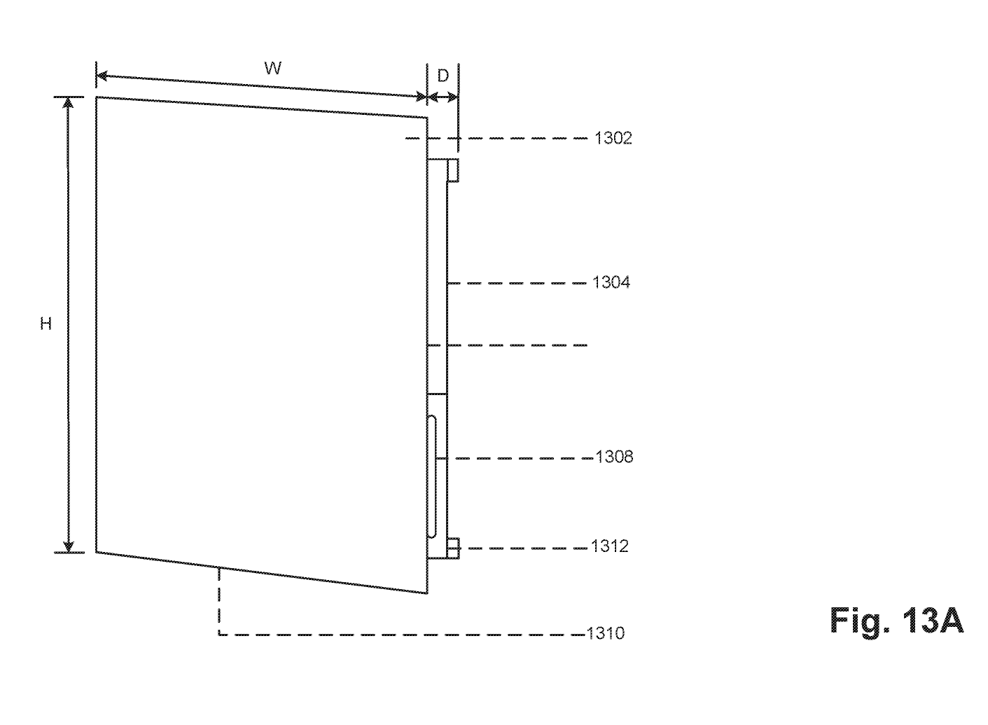

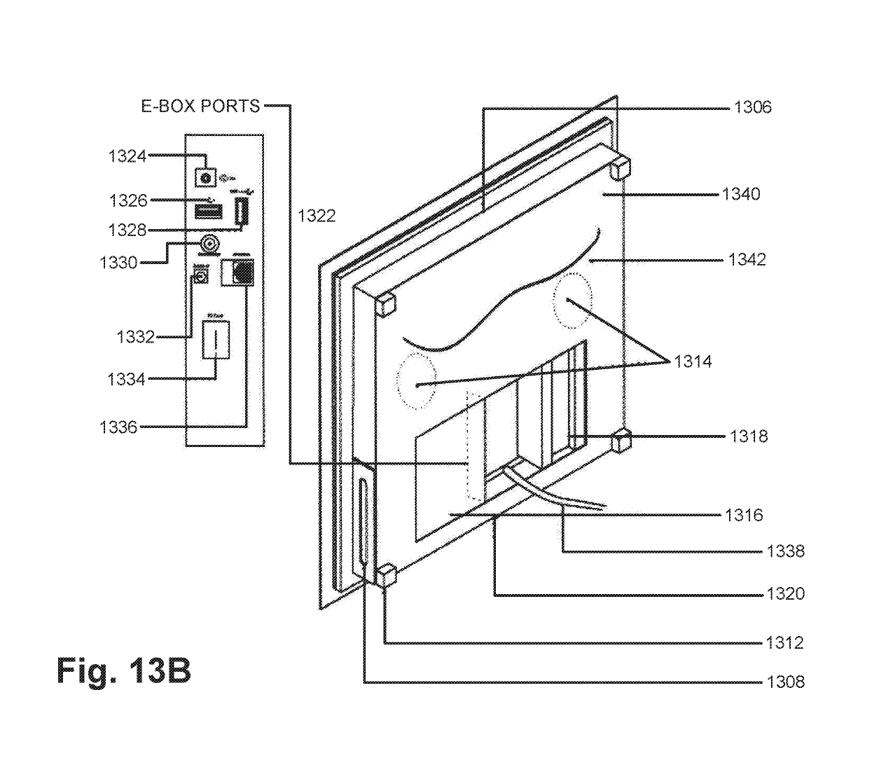

FIGS. 13A - 13B show a further embodiment of a flat panel system 1300 in accordance with the present invention. The illustrated system 1300 includes a speaker panel 1302 mounted on a frame 1304. The panel 1302 is a floating panel that is unframed and extends beyond the edges of the frame 1304, e.g., 2-4 inches beyond the frame 1304 at each edge, so as to create a floating appearance.

The illustrated panel 1302 is formed from aluminum or an aluminum laminate. Such materials allow the entire panel 1302 to resonate for enhanced sound quality. Moreover, the aluminum front surface can be printed with vibrant, high resolution imagery. The frame 1304 may be formed from any material having suitable structural and aesthetic properties and, in the illustrated embodiment, is formed from hand crafted wood.

The illustrated system 1300 further includes lights 1306, such as multiple colored LEDs. As noted above, the lights can serve a number of purposes beyond simple illumination such as providing enhanced ambience, providing a light show coordinated with music, and indicating (e.g., in response to sensing someone has entered the vicinity) that the system is active and available for use. The LEDs are preferably mounted on the back side of the panel 1302 facing the wall to provide back lighting. Moreover, while the LEDs are shown as being on one edge of the panel 1302, the LEDs may be provided at various and/or multiple locations of the panel 1302, e.g., about the full periphery. The LEDs may be programmable to provide different colors, brightness, illumination patterns, or to indicate different operating states.

A volume slider 1308 may be provided to enable touch activated, on-product volume control. For example, the volume slider 1308 may include a softspot touch sensor. The volume control 1308 can be located, e.g., on a side face of the frame 1304 or back surface of the panel 1302 so as not to interfere with aesthetics. The system 1300 may also include a further touch bar 1310 for enabling additional touch controls, e.g., mode selection, song selection, skip, playlist selection, etc. Again, the touch bar 1310 can be located on the frame 1304 or backside of the panel 1310 to avoid interfering with aesthetics. Although the slider 1308 and touch bar 1310 are shown at particular locations on the system 1300, it will be appreciated that they may be positioned at any convenient location.

The frame 1304 may support and house a number of additional electronic components. In this regard, the system 1300 may include a number of audio exciters 1314 (two shown) for driving the panel 1302. As discussed above, the exciters 1314 may implement distributed mode loading for enhanced frequency response and verbal sound quality. The system 1300 may further include an e-box for housing an on-board computer and a power adaptor 1318, such as a 110/220 volt power adapter, for powering various electronic components. The on-board computer can control a variety of functionality as described herein such as processing inputs, controlling the lights 1301 and exciters 1314/power 1302 and networking with other devices. One or more presence sensors 1320, such as infrared sensors, may be provided to sense the presence of a user and/or gesture commands. The sensors 1320 may be hidden behind the bottom of the panel 1302 so as not to interfere with aesthetics.

The system 1300 may also include a variety of ports 1322 as best shown in the blow-up view of FIG. 13B. Although many different types of ports can be supported, the illustrated ports 1322 include a power input 1324 (e.g., a 19 v input), a USB power out port (1326), a wifi dongle 1328, a subwoofer out port 1330, an audio in port 1332, an SD card slot 1334 and an Ethernet port 1336. The system 1300 further includes a power cord 1338 that can hang down from the system or be hidden behind it.

The illustrated system 1300 further includes rubber bumpers 1312, a fabric backing 1340, and an optional hanging wire 1342. The rubber bumpers 1312 inhibit transmission of vibrations from the system 1300 to the wall it is hung/mounted on, and provide clearance for backside sound transmission and passage of cords. The bumpers 1312 preferably provide between ¼-1 inch, e.g., about 0.6 inch clearance between the frame 1304 and wall surface and may be conveniently manufactured by 3D-printing. The fabric backing 1340 keeps dust from various housed components and may be an acoustic material for allowing transmission of sound from the rearside of the panel 1302. The optional hanging wire 1342 allows the system 1300 to be easily mounted on a wall using standard picture hooks or similar hardware.

The panel 1302 can be provided in various sizes such as 24×24 inches, 24×36 inches, 36×36 inches, 36×48 inches, 40×60 inches and custom size. The illustrated system has a width, W, of 24 inches, a height, H, of 24 inches, and a depth, D, of 3.15 inches.

As discussed above, multiple units can be daisy-chained or networked together. In such cases, the units can be independently or collectively controlled to support various effects. The art can moralized across the multiple units if desired.

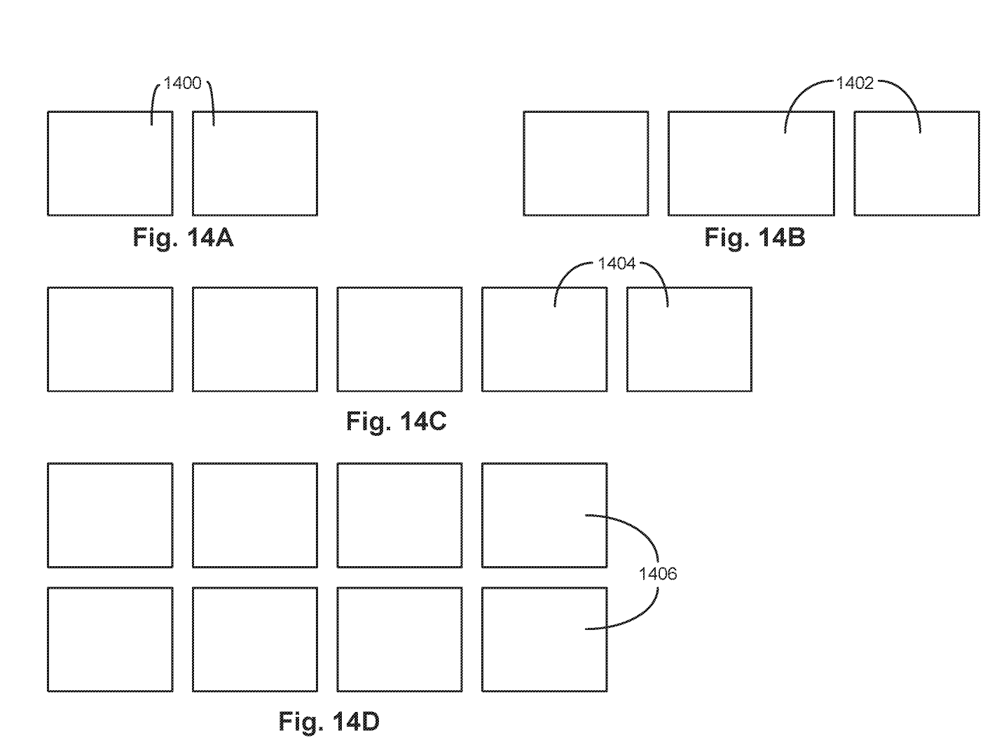

FIGS. 14A-14D show a number of examples in this regard. Specifically, FIG. 14A shows a simple array including two units 1400. As shown in FIG. 14B, the units 1402 can vary in size. FIG. 14C shows a linear array of five units 1404 whereas FIG. 14D shows a two-dimensional array of eight units 1406. It will be appreciated that many other configurations are possible including three-dimensional arrays, e.g., using different walls of a room.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed:

1. An intelligent audio device, comprising:
at least one flat speaker panel for producing acoustic signals;
at least one audio exciter, associated with said flat speaker panel, for driving said flat speaker panel to produce acoustic signals in response to electronic audio signals;
a sensor system for sensing stimuli in an environment of the flat speaker panel, said stimuli being free from encoded electronic signals;
processing logic, operatively associated with the sensor, for detecting one or more events based on said stimuli; and
a processor for executing one or more predefined functions responsive to said events, and for providing an audio output via said flat speaker panel;
said at least one audio exciter and said flat speaker panel being supported by a common structural unit for mounting on a wall.

2. An intelligent audio device as set forth in claim 1, wherein said sensor system comprises a microphone and said processor logic comprises audio processing logic for processing an audio input from said microphone.

3. An intelligent audio device as set forth in claim 2, wherein said audio processing logic comprises speech recognition logic for recognizing at least one speech based command.

4. An intelligent audio device as set forth in claim 2, wherein said audio processing logic comprises ambient sound logic for recognizing an ambient condition and controlling operation of said flat speaker panel responsive to said ambient condition.

5. An intelligent audio device as set forth in claim 4, wherein said ambient condition comprises one of a conversation, a phone call, and a competing audio signal, and said controlling comprises one of reducing a volume and muting said flat speaker panel.

6. An intelligent audio device as set forth in claim 4, wherein said ambient condition comprises sensing one of a presence, an identity, a mood, and an audio preference of at least one person associated with said flat speaker panel.

7. An intelligent audio device as set forth in claim 6, wherein said step of controlling comprises controlling one of a volume and an audio content of said audio output.

8. An intelligent audio device as set forth in claim 1, wherein said sensor system comprises one or more motion sensors.

9. An intelligent audio device as set forth in claim 8, wherein said processing logic identifies a presence of a person in proximity to said sensor system and executes a function involving said flat speaker panel responsive to said presence.

10. An intelligent audio device as set forth in claim 8, wherein said processing logic identifies a gesture of a person in proximity to said sensor system and executes a function involving said flat speaker panel responsive to said gesture.

11. An intelligent audio device as set forth in claim 1, wherein said sensor is a touch sensor for sensing a touch by a user.

12. An intelligent audio device as set forth in claim 11, wherein said sensor is a touch sensor for sensing said flat speaker panel and executes a function involving said flat speaker panel responsive to said touch.

13. An intelligent audio device as set forth in claim 1, wherein said processor is operative for activating an illumination system responsive to one or more of said events.

14. An intelligent audio device as set forth in claim 1, further comprising a network port for connections to a communications network.

15. An intelligent audio device as set forth in claim 1, further comprising a wireless communications port for communicating with a wireless device.

16. An intelligent audio device as set forth in claim 15, wherein said processor is operative for executing a function based on a command received via said wireless communications port.
